(19) United States
(12) Patent Application Publication
(10) Pub. No.: US 2024/0280839 A1
(43) Pub. Date: Aug. 22, 2024

(54) Magnetically Engaged Eyewear Protection System (MEEPS)

(71) Applicant: James Logan, Los Angeles, CA (US)

(72) Inventor: James Logan, Los Angeles, CA (US)

(21) Appl. No.: 18/103,130

(22) Filed: Jan. 30, 2023

(51) Int. Cl. G02C 11/00; B43K 29/00

(52) U.S. Cl. CPC G02C 11/00; B43K 29/003

(57) ABSTRACT

A Magnetically Engaged Eyewear Pencil System comprising: a lens frame containing one or more lenses that is elongated between a left and right temple frame arm; having a pair of hinges, each connecting the respective left and right temple frame arms to the ends of the frame having an initial orientation relative the lens frame, a writing utensil magnetically connected to the left or right temple frame arms that may be removed by a user through contact applied force and reattached to either temple frame arms using magnetic force.

### OATH AND DECLARATION

This application was made and authorized by the declarant James Logan who believes himself to be the original inventor of the claimed invention in the application and acknowledges that any willful false statement made in this declaration is punishable under Title 18 U.S.C Section 1001.

### BACKGROUND

### Field of the Invention

This invention relates to a Magnetically Engaged Eyewear Pencil System (MEEPS) with magnetic temple arms that attach to and hold a magnetic writing utensil for application within industrial workplaces, homes, and offices. The invention can be adapted to include different variations of protective and fashionable frames, all of which include integrated magnetic temple frame arms and a magnetically attached writing utensil.

This invention's innovation is borne from its magnetic landing platform running the length of each temple frame arm, compatible with a magnetic writing utensil, allowing a user to safely store that writing utensil between their temple and ear while protecting and/or enhancing the user's eyesight.

### Description of Related Art

Conventional glasses are generally known to include a front frame with one or more lenses fixed within the frame front, and two frame arms. Where a first arm is coupled to the frame by a first hinge and the second frame arm coupled to a second hinge opposite the first arm. These various types of eyewear include without limitation, protective, prescription, reading, sunglasses, and goggles often referred to as “optics.”

The optics industry has long needed eyewear tailored to users who write while wearing optics and need to keep track of their writing utensils while actively reading and working. The market has a demand for a product that permits a user to use a writing utensil while wearing eyewear without searching or loosing track of it. Currently, there are no available optics made to assist users with convenient storage and retrieval of writing utensils. Thus, products on the current market do not provide eyewear that both protect eyesight and offer a quick and simple storage option for users. This invention provides a solution for users by creating a magnetic mechanism for attaching and removing a writing utensil from a user's eyewear.

A solution the Magnetically Engaged Eyewear Pencil System (MEEPS) presents is its ability to be worn, be non-invasive, protect the user's eyesight, and simultaneously provide a storage and retrieval system for writing utensils through integrated programmable magnetic material.

### SUMMARY

One aspect of the invention resides in protective eyewear that has a lens frame, a pair of temple arms that have a magnetic landing platform running the length of each temple frame arm, and a pair of hinge units. The hinge units connect the pair of temple frame arms to the opposite ends of the lens frame which is elongated between the two opposite ends. The temple frame arms have magnets on the top exterior edge of each temple frame arm which are attracted to the writing utensil's magnetic element running the parallel length of the utensil.

In one aspect the magnetically charged writing utensil is attracted to the magnetic landing platform on either left or right temple frame arm of the Magnetically Engaged Eyewear Pencil System (MEEPS). Thus, in its engaged position the writing utensil will rest atop either the left or right temple frame arm, the magnets integrated within the writing utensil and the temple frame arms holding the writing utensil in place. In its disengaged position the writing utensil is removed from the magnetic arm through the contact applied force. A user pulling the writing utensil breaks the magnetic attraction of the writing utensil to the frame arm.

In some embodiments the invention resides in prescription eyewear where the lenses assist a user's vision while the writing utensil is safely retrieved to assist the user in marking objects and platforms. The magnetic writing utensil may then be returned to the magnetic landing platform built into the temple frame arms for storage.

In some embodiments the invention resides in a frame that has fashionable eyewear that are neither protective, nor prescription, and aligned with the user's stylistic preference. The temple frame arms may be any level of thickness and shall maintain a magnetic landing platform for the magnetically attracted writing utensil.

In some embodiments the writing utensil may utilize a carbon graphite, ink, or electronic filament for writing and marking. These embodiments may be mixed with any number of frame embodiments with the utensil remaining magnetically charged. It is important to note that if the writing utensil is a pencil with carbon graphite filament it would be an automatic pencil that need not need to be sharpened. The magnetic utensil may be attached to either left or right temple frame arms.

### BRIEF DESCRIPTION OF THE DRAWINGS

FIG. 1 shows the right-side view of the Magnetically Engaged Eyewear Pencil System (MEEPS) on a user's face, in the engaged position, the magnetic writing utensil magnetically attached atop the right temple frame arm's magnetic landing surface.

FIG. 2 shows the right-side view of the Magnetically Engaged Eyewear Pencil System (MEEPS) in use on a user's face, in the dis-engaged position, the magnetic writing utensil detached from the right temple frame arm's magnetic landing surface.

FIG. 3 shows a front view of the Magnetically Engaged Eyewear Pencil System (MEEPS) on a user's face, the system is in the engaged position, the magnetic writing utensil magnetically attached atop the left temple frame arm's magnetic landing surface.

FIG. 4 shows a front view of the Magnetically Engaged Eyewear Pencil System (MEEPS) on a user's face, the system is in the dis-engaged position, the magnetic writing utensil detached from the left temple frame arm's magnetic landing surface.

FIG. 5 shows the left-side view of the Magnetically Engaged Eyewear Pencil System (MEEPS) in use on a user's face, in the engaged position, the magnetic writing utensil magnetically attached atop the left temple frame arm's magnetic landing surface.

FIG. 6 shows the left-side view of the Magnetically Engaged Eyewear Pencil System (MEEPS) in use on a user's face, in the dis-engaged position, the magnetic writing utensil detached from the left temple frame arm's magnetic landing surface.

FIG. 7 shows the back view of the Magnetically Engaged Eyewear Pencil System (MEEPS), in the engaged position, the magnetic writing utensil magnetically attached atop the left temple frame arm's magnetic landing surface.

FIG. 8 shows the back view of the Magnetically Engaged Eyewear Pencil System (MEEPS), in the dis-engaged position, the magnetic writing utensil detached from the left temple frame arm's magnetic landing surface.

FIG. 9 shows the top view of the Magnetically Engaged Eyewear Pencil System (MEEPS), in the engaged position, the magnetic writing utensil magnetically attached atop the left temple frame arm's magnetic landing surface.

FIG. 10 shows the top view of the Magnetically Engaged Eyewear Pencil System (MEEPS), in the dis-engaged position, the magnetic writing utensil detached from the left temple frame arm's magnetic landing surface.

FIG. 11 shows the front 45-degree rotated right-side view of the Magnetically Engaged Eyewear Pencil System (MEEPS), in the engaged position, the magnetic writing utensil magnetically attached atop the left temple frame arm's magnetic landing surface.

FIG. 12 shows the front 45-degree rotated right-side view of the Magnetically Engaged Eyewear Pencil System (MEEPS), in the dis-engaged position, the magnetic writing utensil detached from the left temple frame arm's magnetic landing surface.

FIG. 13 shows the front rotated 45-degree left-side view of the Magnetically Engaged Eyewear Pencil System (MEEPS), both left and right temple frame arms integrated with magnetic landing platforms inclusive of a plurality of north and south poles, the writing utensil completely removed.

FIG. 14 shows the right-side cross section view of the Magnetically Engaged Eyewear Pencil System (MEEPS), the right temple frame arm's magnetic landing platform integrated with a plurality of north and south poles on each surface of the magnetic element, the writing utensil completely removed.

FIG. 15 shows left-side cross section view of the Magnetically Engaged Eyewear Pencil System (MEEPS), the right temple frame arm's magnetic landing platform integrated with a plurality of north and south poles on each surface of the magnetic element, the writing utensil completely removed.

FIG. 16 shows a cross section view of the Magnetically Engaged Eyewear Pencil System (MEEPS) writing utensil, integrated with a magnetically charged attaching element platform with a plurality of north and south poles on each surface of the magnetic element, the writing utensil is a pencil with carbon graphite type filament and an eraser.

FIG. 16A shows the Magnetically Engaged Eyewear Pencil System (MEEPS) writing utensil integrated into a mechanical pencil.

FIG. 17 shows a cross section view of the Magnetically Engaged Eyewear Pencil System (MEEPS) writing utensil, integrated with the magnetically charged attaching element platform with a plurality of north and south poles on each surface of the magnetic element, the writing utensil is a pen with ink type filament.

FIG. 18 shows an embodiment of the Magnetically Engaged Eyewear Pencil System (MEEPS) where the eyewear frames are prescription eyewear.

FIG. 19 shows an embodiment of the Magnetically Engaged Eyewear Pencil System (MEEPS) where the eyewear frames are protective eyewear.

FIG. 20 shows an embodiment of the Magnetically Engaged Eyewear Pencil System (MEEPS) where the eyewear frames are fashionable eyewear.

### DETAILED DESCRIPTION OF THE DRAWINGS

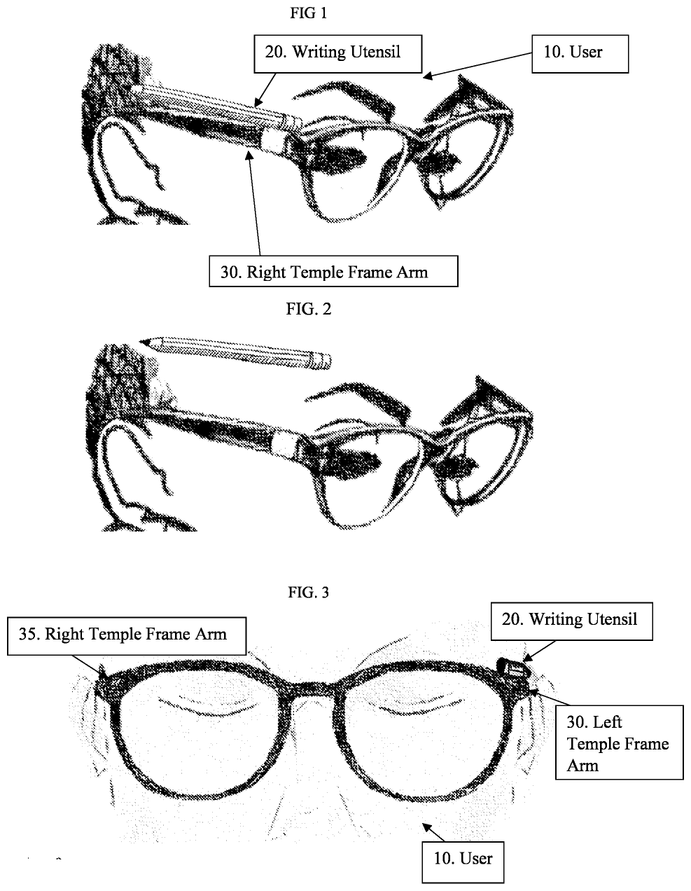

FIGS. 1, 3, 5, 7, 9, show different angles of the Magnetically Engaged Eyewear Pencil System (MEEPS) with the user 10 wearing the protective eyewear system in its engaged position. The left temple frame arm 30 and right temple frame arm 35 of the system sit between the user's earlobe and temple in the same manner a user would wear common eyewear. The writing utensil 20 may be magnetically attached either the right arm magnetic landing platform 36 or the left temple frame arm magnetic landing platform 31. The left temple frame arm 30 and right temple frame arm 35 landing platforms have a plurality of north and south poles 40 on each surface of the magnetic element. The figures show the writing element 21 of the writing utensil 20 facing the back of the user's head.

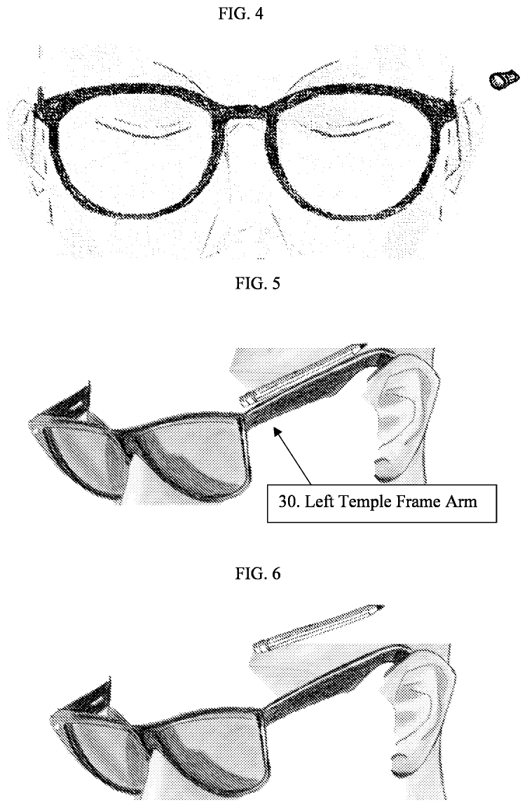

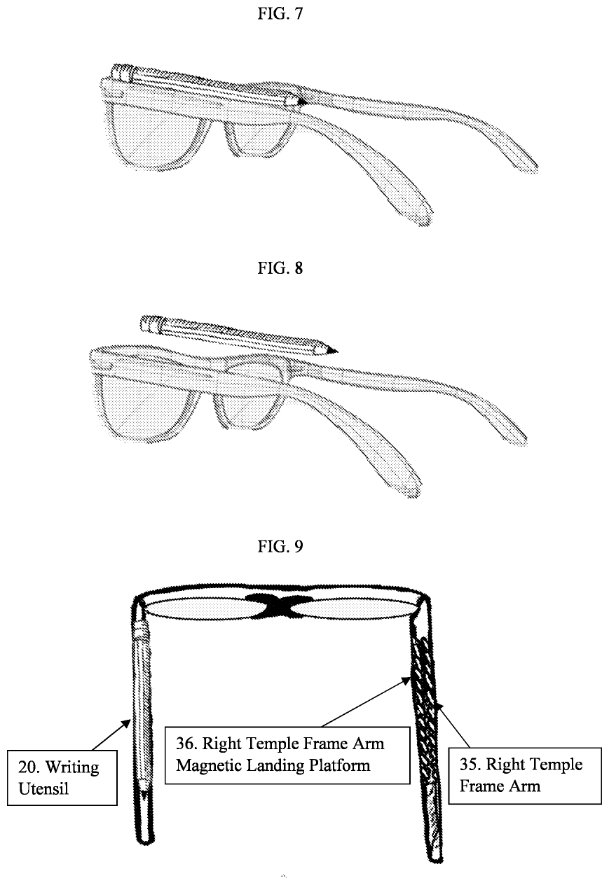

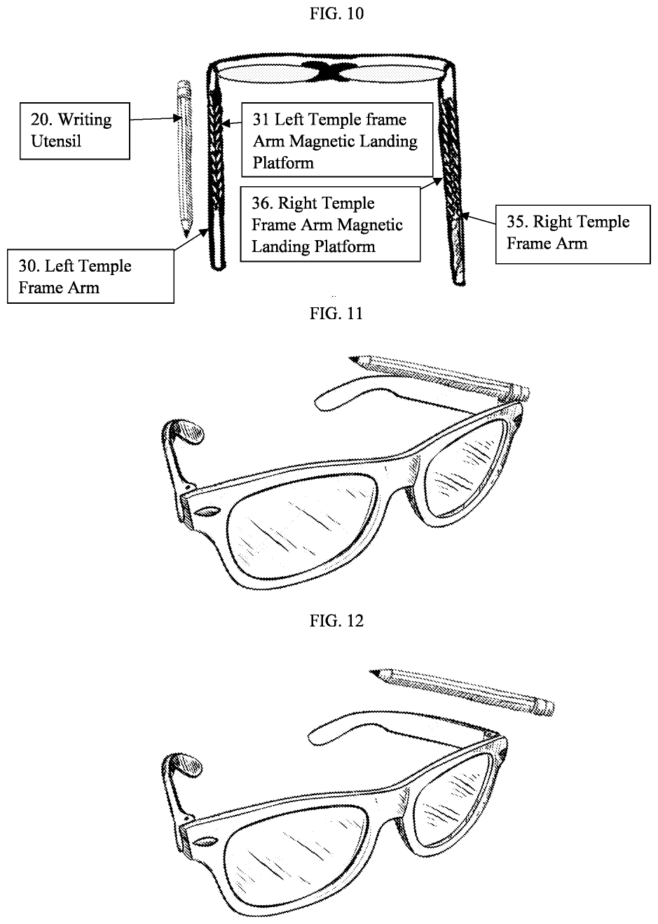

FIGS. 2, 4, 6, 8, 10 show different angles of the Magnetically Engaged Eyewear Pencil System (MEEPS) with the writing utensil 20 removed, the system is in the dis-engaged position. Here the magnetic writing utensil 20 can be unseated through applied contact force. The user can break the magnetic bond by lifting the writing utensil 20, as attached, from either the left temple frame arm magnetic landing platform 31 or right temple frame arm landing platform 36. The magnetic bond between the writing utensil 20 and the magnetic landing platform on either temple frame arms prove the system does not need an additional mechanism for the user to lock the writing utensil in place on either temple frame arm or to remove and engage the writing utensil 20.

FIG. 11 shows a slightly elevated right-side view of the magnetically engaged Magnetically Engaged Eyewear Pencil System not in use on a user's face. The writing utensil 20 is seated on the right temple frame arm's magnetic landing platform 36.

FIG. 12 shows a slightly elevated right-side view of the magnetically dis-engaged Magnetically Engaged Eyewear Pencil System not in use on a user's face. The writing utensil 20 is shown next to the right frame arm's magnetic landing platform 36.

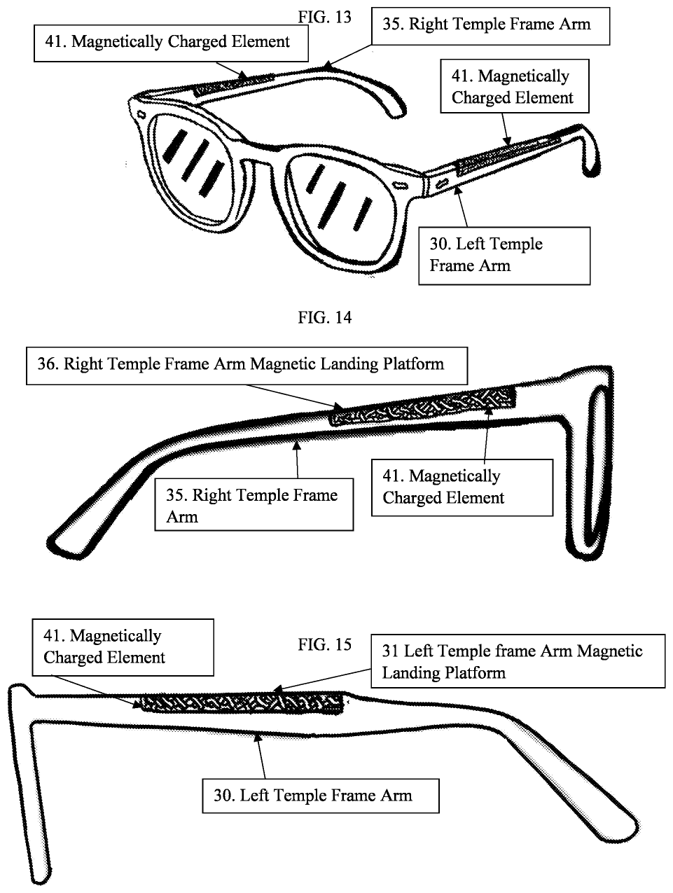

FIG. 13 shows a slightly elevated front top view of the Magnetically Engaged Eyewear Pencil System. Integrated within both temple frame arms the magnetically charged element 41 is shown present on both left and right frame arm landing platforms, each with a plurality of north and south poles 42 on each surface of the magnetic element. This shows how the system looks with the writing utensil 20 completely removed. Shown here, the magnetic landing platform is seamlessly integrated within both frame arms

FIGS. 14 and 15 show left and right angles of a cross section view of the Magnetically Engaged Eyewear Pencil System. The magnetic landing platforms present on both left and right temple frame arms. These figures show how seamlessly each magnetic platform with a plurality of north and south poles on each surface of the magnetic element, is integrated atop both temple frame arms.

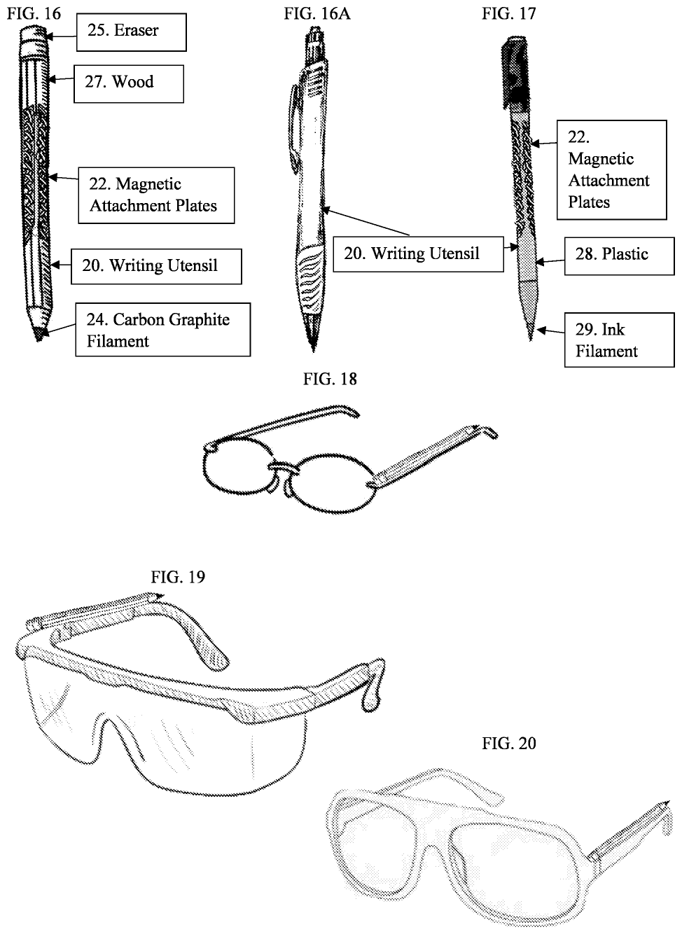

FIG. 16 shows a cross section view of the writing utensil 20, integrated with magnetic attachment plates 22, forming a plurality of north and south poles 23 on each surface of the magnetic attachment plate 22. This figure shows magnetic elements integrated into a writing utensil 20 made of wood 27 or similar. The writing element 21 material is made of carbon graphite 24 type filament and an eraser 25. This configuration is not limited to wood like encasing and ink filament 29, it can be made from any material.

This embodiment provides a safe way for the user to store and save a writing utensil 20 which includes a magnetic element. The magnetic attachment plates 22 of the writing utensil 20 are attracted to and seek magnetic bonding with both left and right temple frame arm.

FIG. 16A shows the system integrated into a mechanical pencil which has no need to be sharpened.

FIG. 17 shows a cross section view of the writing utensil 20, integrated with magnetic attachment plates 22, forming a plurality of north and south poles 23 on each surface of the magnetic attachment plate 22. This figure shows magnetic elements integrated into a writing utensil 20 made of plastic 28, or similar, material with the writing element 21 material made of ink 29 filament. This configuration is not limited to plastic 28 type encasing and ink 29 filament and can be made from any material. Additionally, the writing utensil 20 may be electronic in nature and made from any material.

FIGS. 18, 19, and 20 show the Magnetically Engaged Eyewear Pencil System in a variety of embodiments where the eyewear frames are either prescription, fashionable or otherwise. These figures are in no way limiting and the system can be made from any design or user preference with the frame arms and writing utensil including the above mentioned magnetically attracted landing platform components.

In summary, the combination of applications and/or solutions outlined above are exemplary, these detailed embodiments and/or illustrations shall not be limiting in any sense, because numerous combinations are feasible. The particular examples described above may represent a small number of existing solutions. Thus, various details described may be either executed as illustrated and/or described, or in a combination of other sequences, or omitted. That said, the order of the above-described configurations, processes and applications may be changed.

Regarding the above-mentioned aspects and features of the Magnetically Engaged Eyewear Pencil System, it should be noted that the invention further encompasses the various logical combinations and sub-combinations of the cited aspects and features.

1. What is claimed is a Magnetically Engaged Eyewear Pencil System comprising: a lens frame containing one or more lenses that is elongated between a left and right temple frame arm; having a pair of hinges, each connecting the respective left and right temple frame arms to the ends of the frame having an initial orientation relative the lens frame, and a writing utensil magnetically connected to the left or right temple frame arm.

2. The Magnetically Engaged Eyewear Pencil System of claim 1, wherein an integrated magnetic element is embedded into each left and right temple frame arm forming a magnetic landing platform for the magnetic writing utensil.

3. The Magnetically Engaged Eyewear Pencil System of claim 1, where the magnetic element integrated within the writing utensil is configured to magnetically engage the landing platform surface on either left or right temple frame arms.

4. The Magnetically Engaged Eyewear Pencil System of claim 2, wherein the magnetic material integrated within both temple frame arms is a polymagnet and or ferromagnetic material with magnetic domains pointed in the same direction, embracing at least one north pole and one south pole on the surface of the left and right temple frame arms.

5. The Magnetically Engaged Eyewear Pencil System of claim 3, wherein the integrated magnetic material consists of magnetic domains that are pointed in the same direction inclusive of an opposite magnetic field to that of the magnetic landing platform integrated within the left and right temple frame arms.

6. The Magnetically Engaged Eyewear Pencil System of claim 5, wherein the magnetic material integrated within the writing utensil is magnetically attracted to the magnetic landing platform integrated within both left and right temple frame arms.

7. The Magnetically Engaged Eyewear Pencil System of claim 6, wherein the magnetic writing utensil may be detached from the magnetic landing platform of either left or right temple frame arm through contact applied force and re-attached to either left or right temple frame arm through magnetic force.

8. The Magnetically Engaged Eyewear Pencil System of claim 1, wherein the frame may be made with any thickness, height, and material, while maintaining a polymagnet and or ferromagnetic material integrated within the magnetic landing platform of both temple frame arms.

9. The Magnetically Engaged Eyewear Pencil System of claim 1, wherein the lenses may be made with any thickness, height, and material including but not limited to prescription, non-prescription, self-tinting, and progressive.

10. The Magnetically Engaged Eyewear Pencil System of claim 1, wherein the writing utensil is made from any material with any filament that can safely be used for writing and marking including but not limited to carbon graphite, ink, and electronic means.

11. The Magnetically Engaged Eyewear Pencil System of claim 1, wherein the writing utensil is elongated and attached with the writing portion facing away from the lens along the temple arm magnetic landing platform toward the back of the system.
